(19) United States
(12) Patent Application Publication
(10) Pub. No.: US 2013/0215101 A1
(43) Pub. Date: Aug. 22, 2013

(54) ANAMORPHIC DISPLAY

(71) Applicant: MENG-GE DUAN, CHENGDU SICHUAN (CN)

(72) Inventor: MENG-GE DUAN, CHENGDU SICHUAN (CN)

(73) Assignee: MOTOROLA SOLUTIONS, INC., Schaumburg, IL (US)

(21) Appl. No.: 13/401,079

(22) Filed: Feb. 21, 2012

(51) Int. Cl. G06T 15/00

(52) U.S. Cl. 345/419

(57) ABSTRACT

An anamorphic display device is provided herein. The display device produces anamorphically-displayed elements via a visual three-dimensional illusion for two-dimensional content element of a viewing surface. Context-aware circuitry may determine a viewpoint, and the viewpoint can be used to determine an angle where viewing ray intersects the viewing surface. A geometric algorithm is used to reconstruct the two-dimensional content element appropriately on the viewing surface. The observer can observe the three-dimensional illusion of the two-dimensional content element out of the plane viewing surface in the observer's perspective at the viewpoint, as if the original two-dimensional content element were placed in the three-dimensional space. This allows easier viewing of material at off angles.

### FIELD OF THE INVENTION

The present invention generally relates to devices that display information, and more particularly to devices that use an anamorphic technique to display information.

### BACKGROUND OF THE INVENTION

Many devices that display information are often viewed from an angle. For example, a police radio hanging from an officer's belt is often viewed from an angle, as the officer looks down at the radio. Because of this, an observer is often required to view the content by tilting the device, or placing the screen in front of him (i.e. the viewpoint is in front of the screen and the observer's viewing ray is perpendicular to the screen). However, in case when the observer cannot face the screen, the content element on the screen is less recognizable from the observer's perspective. As an observer's view ray inclines and becomes more parallel to the screen, the content recognition decays dramatically.

Prior-art techniques exist that distort an image, so when viewed from an angle, gives the user a correct perspective of the image. For example, a painting technique called anamorphosis, is designed to produce this effect, and dates back to the Renaissance. With this technique, objects are painted so that they appear to have a correct perspective when viewed from an angle, instead of straight on as in a normal panting. In the modem era such paintings are sometimes created on sidewalks or public squares by artists and are rendered so a person walking toward them along a sidewalk will, at least for a moment, see a correctly proportioned image of an object or person sitting on the sidewalk in front of them.

These prior-art techniques have been used to create three-dimensional displays on a two-dimensional screen. For example, United States Patent Application Publication No. 2009/115783, entitled “two-dimensional Optical Illusion from Off-Axis Displays” shows a technique where a camera captures an image that is then displayed as a three-dimensional image. Such prior-art techniques often requires the use of special glasses to view the image correctly, or requires a camera to capture an image of what is displayed prior to displaying the image.

It would be beneficial if a technique was developed that could utilize an anamorphic technique to aide in viewing screen content for devices that display information, and are often viewed from an angle. It would also be beneficial if such a display did not require the use of special glasses to view the display, and did not require a camera to capture the image prior to displaying the image.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 illustrates face-on viewing of content on a screen;

FIG. 2 illustrates angled viewing of content on a screen;

FIG. 3 is a block diagram of a display device;

FIG. 4 through FIG. 7 illustrates an anamorphic display on the display device of FIG. 3.

FIG. 8 is a flow chart showing operation of the display device of FIG. 3.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the above-mentioned need, an anamorphic display device is provided herein. The display device produces a visual three-dimensional illusion for two-dimensional content elements on a viewing surface via anamorphically-displaying those elements. Context-aware circuitry may determine a viewpoint, and the viewpoint can be used to determine an angle where a viewing ray intersects the viewing surface. A geometric algorithm is used to reconstruct the two-dimensional content element appropriately on the viewing surface. The observer can observe the three-dimensional illusion of the two-dimensional content element out of the plane of the viewing surface in the observer's perspective at the viewpoint, as if the original two-dimensional content element were placed in three-dimensional space. This allows easier viewing of material at off angles.

In one embodiment of the present invention, display device prioritizes certain text to be displayed anamorphically, and only displays the prioritized text anamorphically. Additionally, certain symbols that exist on the screen may not be displayed anamorphically.

In normal displays, two-dimensional content (such as text, images, tables, diagrams, . . . , etc.) is usually placed or displayed on a plane viewing surface for observer to see. It is supposed that the viewpoint is in front of the viewing surface and the observer's viewing ray is perpendicular to the viewing surface so that the content element can be seen clearly by the observer. However, in case that the viewpoint is not in front of the viewing surface and the observer's viewing ray intersects the viewing surface at an angle (0°<σ<90°), the content element on the viewing surface is less recognizable in the observer's perspective. As the viewing distance increases and the intersecting angle decreases, the content element may be completely not recognizable in the observer's perspective.

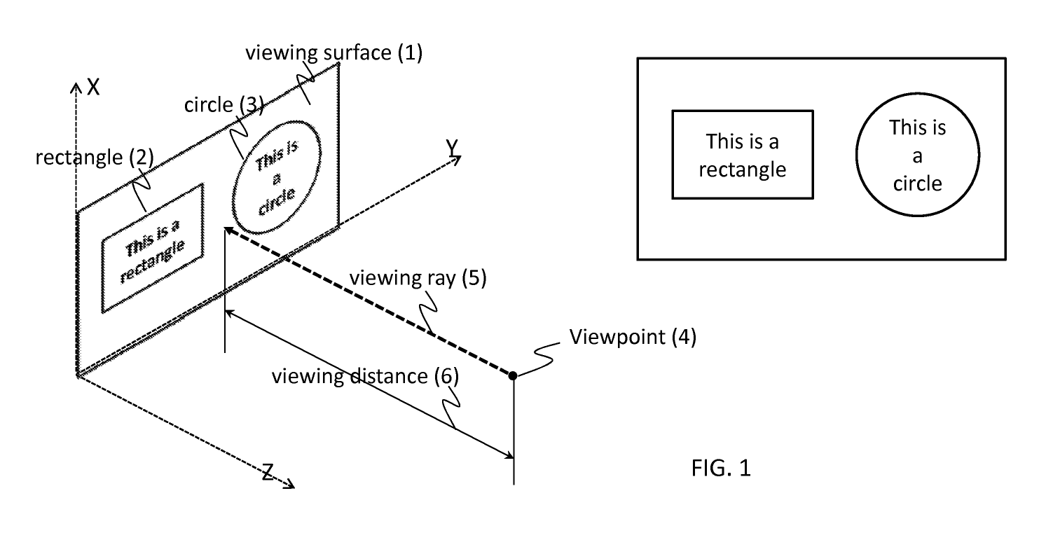

As shown at the left side of FIG. 1, an observer observes the rectangle 2 and the circle 3 on the viewing surface 1 at the viewpoint 4 with a viewing distance 6 in the Z direction. The viewpoint is in front of the viewing surface and the observer's viewing ray is perpendicular to the viewing surface. The shape and text the observer can see in his perspective is shown at the right side of FIG. 1. As a result, the content elements are clearly seen by the observer.

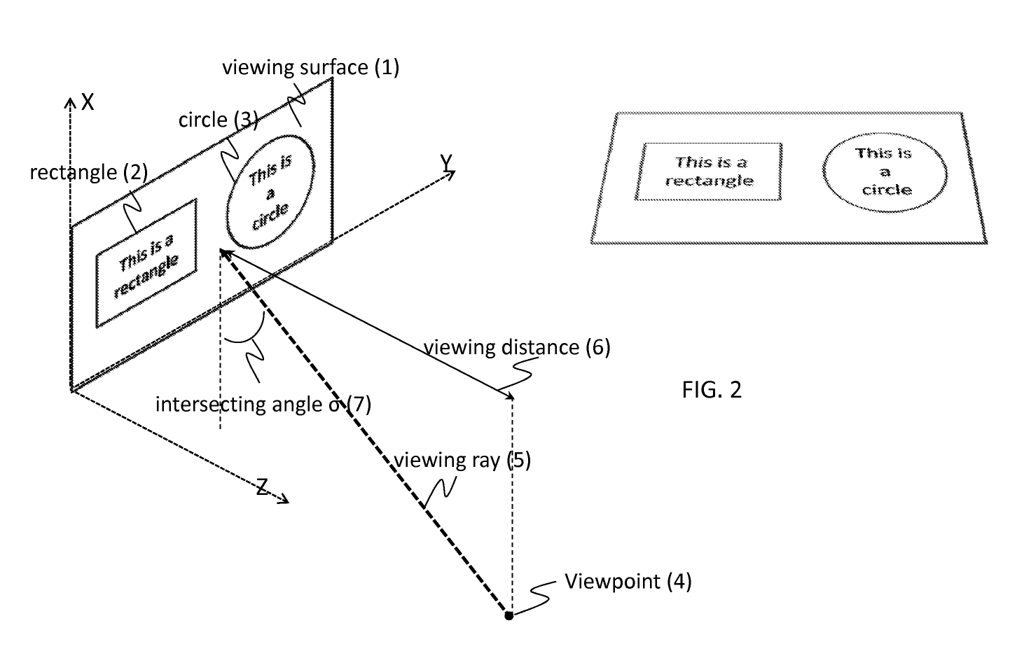

As shown at the left side of FIG. 2, the same observer observes the same rectangle 2 and circle 3 on the same viewing surface 1. The viewing distance in Z direction is not changed, however, the viewpoint is moved down in the X direction. Thus the viewing ray intersects the viewing surface at an angle σ7. The shape and text the observer can see in his perspective is shown at the right side of FIG. 2. As a result, the content elements are distorted and they are less recognizable. As the intersecting angle decreases, the recognition for the content elements decays dramatically.

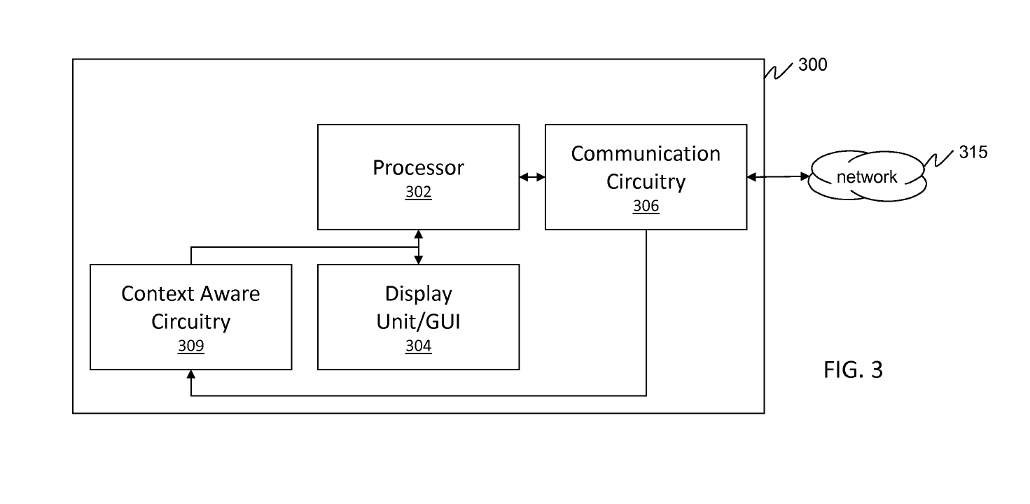

In order to address this issue a display device will anamorphically display certain text so that it is more recognizable by a viewer of the text at intersecting angle 7. Such a device is shown in FIG. 3. More particularly, FIG. 3 is a block diagram showing display device 300. Display device 300 preferably comprises a public-safety radio, such as a Motorola Solutions Astro police radio. However, in alternate embodiments, display device 300 may comprise any device capable of displaying information. Such devices include, but are not limited to personal computers, tablet computers, cellular telephones, handheld electronic devices, . . . , etc.

As shown display device 300 includes processor 302, communication circuitry 306, context-aware circuitry 309, and display 304. Processor 302 preferably comprises logic circuitry such as a microprocessor and is configured to perform the necessary steps to appropriately morph text as described below. Processor 302 communicates with display 304 and communication circuitry 306. Display 304 preferably comprises a touch screen display, but may comprise any display capable of displaying information to a user. Display unit 304 also serves as a graphical user interface (GUI) used to receive input from a user. In one embodiment of the present invention, display 304 is recessed into device 300 so that it is inclined to an observer's frequent viewpoints.

Communication circuit 306 comprises one or more of a network interface card, cellular modem, or Wi-Fi modem incorporating 802.11 a/b/g/n. Communication circuitry 306 communicates to other network devices through network 315. Finally, context-aware circuitry 309 comprises any circuitry capable of generating a current context. For example, context-aware circuitry 309 may comprise a GPS receiver capable of determining a location of the user device. Alternatively, circuitry 309 may comprise such things as a clock, level, accelerometer, a barometer, speech recognition circuitry, face-recognition circuitry, a user's electronic calendar, short-range communication circuitry (e.g., Bluetooth™ circuitry) to determine what other electronic devices are near . . . , etc.

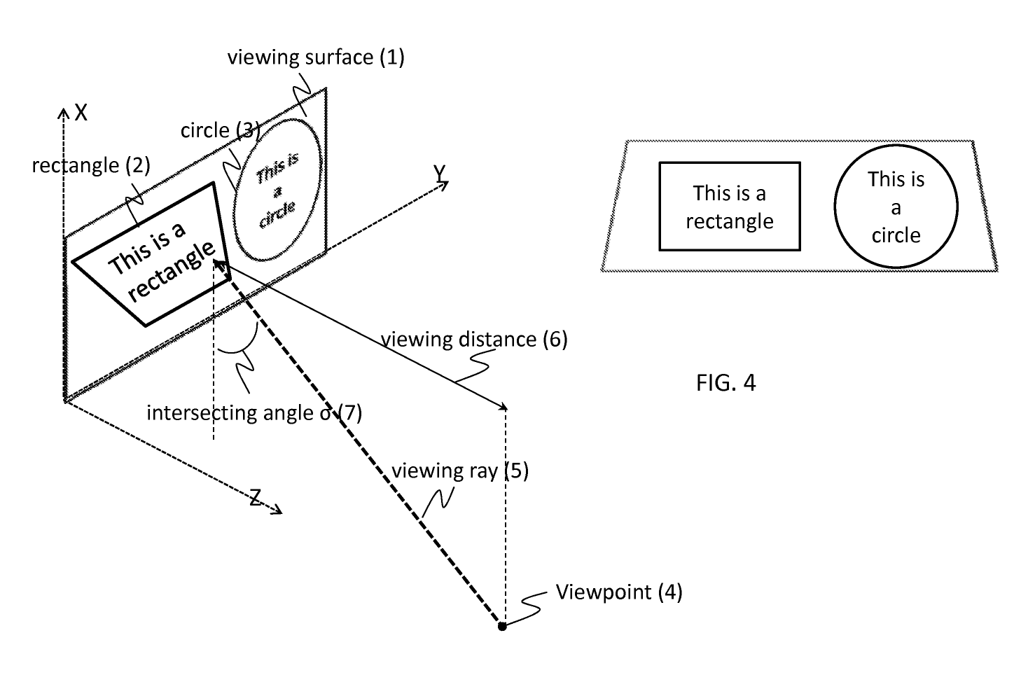

During operation of device 300, context-aware circuitry will continuously feed contextual information to processor 302. In one embodiment of the present invention circuitry 309 will provide information on whether or not device 300 is located on a belt, or in a hand. This can be accomplished by circuitry 309 determining its angle with respect to vertical or horizontal. Processor 302 can utilize this information in order to morph text sent to display unit 304. Thus, the observer who observes at the same viewpoint as that shown in FIG. 2 could see the content elements in his perspective as the same as those shown in FIG. 1. More particularly, certain material on display 304 looks to the observer as if the two-dimensional content elements popped out the original viewing surface into the three-dimensional space and rotated towards the observer with an angle equal to σ. Thus the observer's viewing ray is perpendicular to a new virtual viewing surface on which content elements are clearly seen. This is illustrated in FIG. 4.

As shown in FIG. 4, processor 302 reconstructs the geometric shape of the content element on the viewing surface using an algorithm basing on the viewing distance and the intersecting angle. When the observer changes to a new viewpoint and the viewing distance is relatively much larger than the size of the content element, the reconstructed content element produces visual illusion to the observer, which makes the observer think the content element turns towards to him in his current perspective.

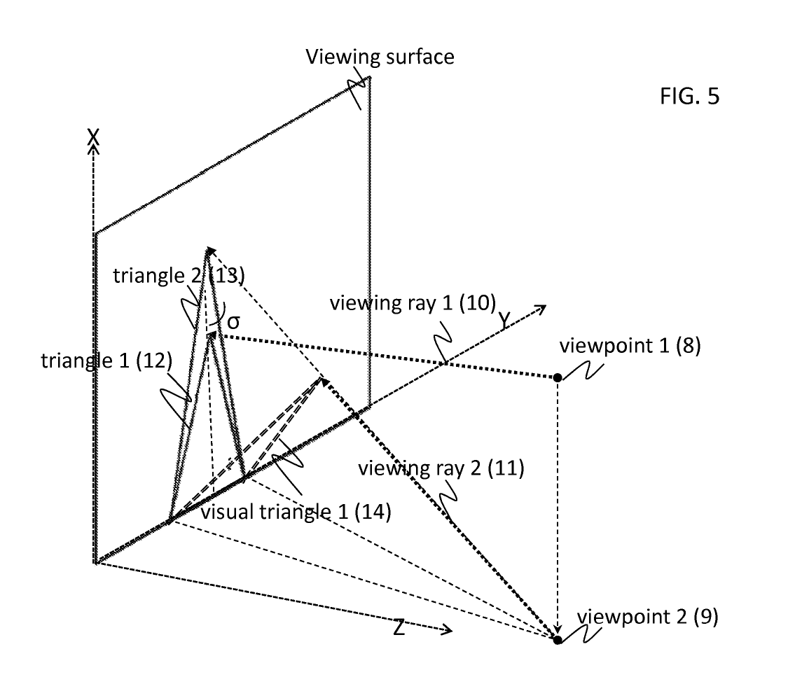

FIG. 5 shows how processor 302 morphs text by illustrating a view of a triangle when the observer changes viewpoint from the viewpoint 1 (8) to the viewpoint 2 (9). The triangle 1 (12) is observed at the viewpoint 1 (8). When the observer moves to the viewpoint 2 (9), where the viewing ray 2 (11) intersects the viewing surface at an angle σ, the triangle 1 (12) is reconstructed to be the triangle 2 (13) on the viewing surface. The visual triangle (14) can be observed in observer's current perspective which is visually identical to the triangle 1 (12).

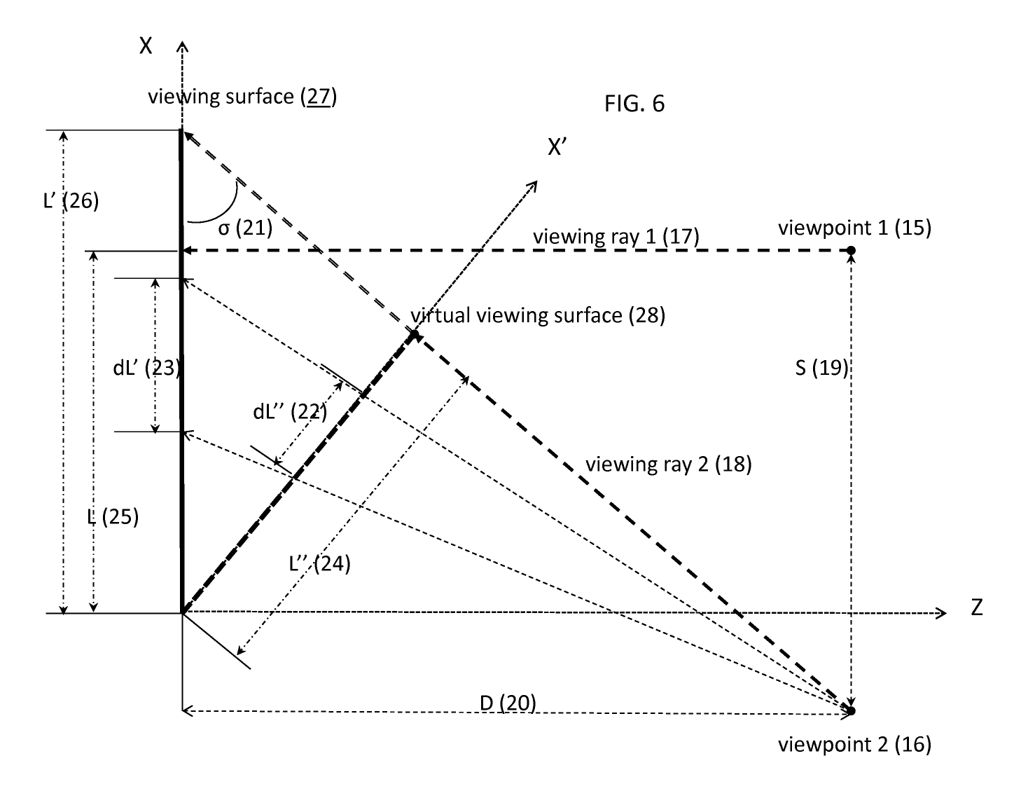

FIG. 6 illustrates the transverse section of the FIG. 5 along Y axis. When the observer moves from the viewpoint 1 (15) to the viewpoint 2 (16), the content element L (25) (i.e. the triangle 1 (12) in FIG. 4) on the viewing surface 1 (27) needs to be reconstructed appropriately to be the L′ (26) to produce an illusion (L″ (24)) of the same content element on the virtual viewing surface (27). The L″ (24) is visually identical to the L (25). The relationship between infinite differential of the L″ (24) (dL″ (22)), and that of the L′ (26) (dL′ (23)) is shown in FIG. 6. The relationship is basically determined by the viewing distance in Z axis (D (20)) and the distance between the two viewpoints in X axis (S (19)). By performing integration, L′ (26) can be constructed.

The foregoing description describes how this method produces illusion to the observer when they move to a new viewpoint in the X direction only. Basically, the observer may move to an arbitrary new viewpoint in three dimensions.

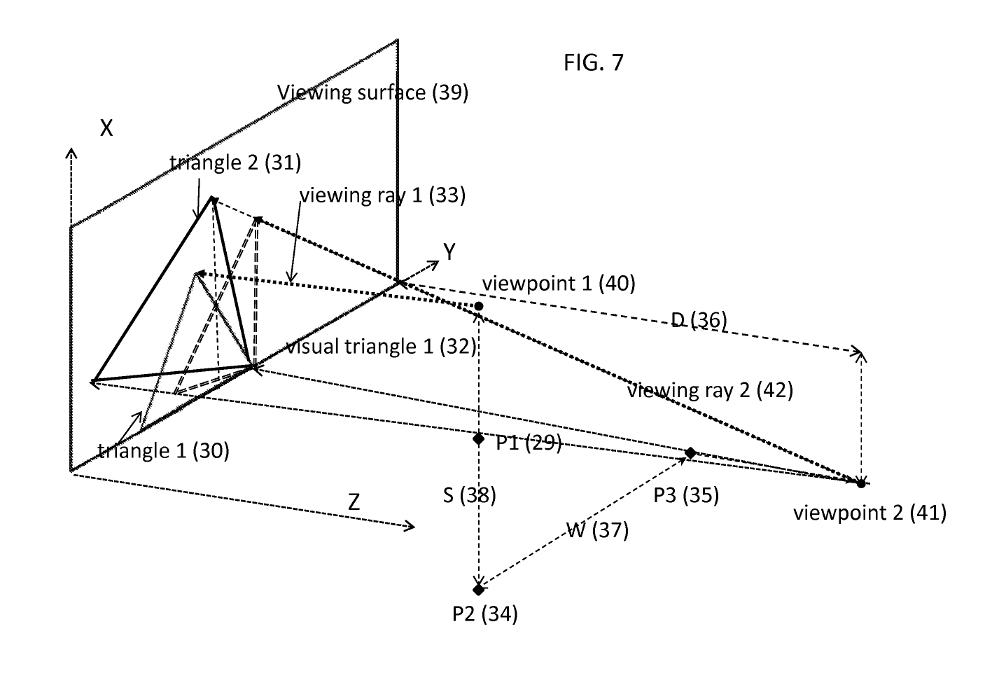

FIG. 7 illustrates a more generic scenario when the observer moves from the viewpoint 1 (40) to an arbitrary new viewpoint 2 (41). In fact, the observer's movement can be interpreted as:

1. Observer moves from the viewpoint 1 (40) to P2 (34) on the X axis where the distance is S (38). (He passes P1 (29) where he passes through the Z-Y plane. The Z-plane is perpendicular to the viewing surface).

2. Observer moves from P2 (34) to P3 (35) on Y axis and the distance is W (37).

3. Observer moves from P3 (35) to the viewpoint 2 (41) on Z axis. The total distance on Z axis is D (36).

Thus, the moved distance on X, Y and Z axis is S (38), W (37) and D (36) respectively. By using method illustrated in FIG. 6, the content element (the triangle 1 (30)) is reconstructed in X direction basing on S (38) and D (36). And it is also reconstructed in Y direction basing on W (37) and D (36). As a result, the final reconstructed triangle is the triangle 2 (31) on the viewing surface (39). The observer can observe an illustration of the original triangle 1 (30), which is in fact the virtual triangle 1 (32).

After reconstruction in the Y direction, the text needs to be skewed when a position changes in both x and y directions (i.e. we move viewing point from a to b). Thus, the reconstructed element is skewed basing on the S (38) and W (37).

### Determining an Observer's Viewpoint

In order to determine the viewpoint of an observer, an angle of the device with respect to the viewer is necessary. This can be estimated based on an estimation of an orientation of the display, and a distance between the display and the viewer. With this in mind, a device may be equipped with context-aware circuitry, for example, a level to determine an orientation of the display device with regards to horizontal. An angle of the display from horizontal can be utilized to approximate a viewing angle of the display.

Since both angle detection and viewing distance detection are needed to approximate a viewing angle. The distance detection can be estimated basing on a user's environmental context. For example, when a police officer is on patrol, the radio is clipped on a belt, the viewing distance then should be the average eye to hip range. In one embodiment, near-field distance circuitry can be utilized to determine a distance to the observer. In another embodiment, GPS circuitry is used to estimate a user's location and speed. The location of the user is then used to estimate a distance that a viewer is from the display. For example, if GPS circuitry indicates a walking speed, it is likely that a police officer has his radio clipped to a belt. Alternatively, if GPS circuitry indicates a high-rate of speed, it is likely that the police officer is driving, and has his radio seated near a dashboard of the automobile. This information may be taken into consideration when estimating a distance that a viewer is from the display. Thus, processor 302 may morph certain text based on a device's location and/or speed. For example, when a police officer is walking on patrol, information may be morphed, since the officer's radio is usually located on their belt, and viewed from an obtuse angle. In a similar manner, when a police officer is in their automobile (determined by the speed of the device), the radio is usually placed in a holder for easier viewing. In this situation text may not be anamorphically morphed.

In another embodiment of the present invention, context-aware circuitry 309 comprises face-recognition circuitry. A user's eyes may be recognized in a field of view, and an appropriate position of the user's eyes may be determined in relation to display 304. Processor 302 can then use this information to determine an appropriate way to morph information displayed on display 304.

In yet another embodiment, context-aware circuitry 309 comprises an electronic level that can determine the display's angle to horizontal. Since a user's eyes can be assumed to be looking down slightly from horizontal, an angle of viewing may simply be estimated by using this information. For example, assuming that device 300 is a radio that is typically hung from a belt, and that display 304 is located on the outside of device 300, opposite of the user's belt, then, as the display becomes more horizontal, the user's viewing angle decreases, so that when the display is horizontal, the user views the display from approximately straight on (90 degrees).

In yet another embodiment, context aware circuitry comprises sensors that determine when device 300 is being held. Such sensors may comprise, for example, a simple capacitive touch sensor, or a simple resistive touch sensor that determines when skin is in contact with device 300. When held, no morphing takes place. When device 300 is not held, any technique to morph information on display 304 may take place. In this embodiment, it is assumed that when held, the user can adjust display 304 accordingly so that morphing of information on display 304 is not needed.

### Determining What Visual Information to Morph

Since morphing an image reduces an amount of information that may be displayed on display 304, in one embodiment of the present invention, only certain information on display 304 is morphed. In one embodiment, communication circuitry 306 receives information from network 315 that is to be displayed. Such information may include a user identification of a calling party, a group identification of a calling party, or any other information needing to be displayed on display 304. Such information is usually displayed as text on display 304.

As one of ordinary skill in the art will recognize, display 304 may also display other non-essential information such as volume level, remaining battery life, signal strength, . . . , etc. This information is generally displayed as symbols or pictures on display 304. In one embodiment, symbols are given a lower priority than text, such that text will be morphed as describe above, while symbols will not be morphed. Additionally, if the morphing of text is such that the morphed text exists where the symbols usually exist, then the symbols may be removed in favor of the morphed text. So for example, caller identification may be morphed, while remaining battery life may not be morphed. Additionally, a remaining-battery-life symbol may be removed to accommodate morphing of caller identification.

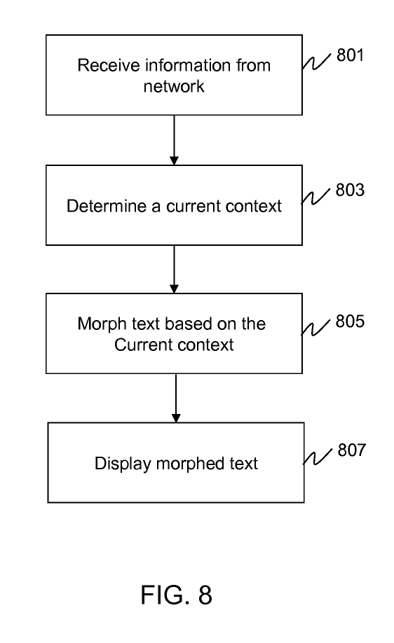

FIG. 8 is a flow chart showing operation of device 300. The logic flow begins at step 801 where communication circuitry 306 receives information from network 315 and passes this information to processor 302. Such information may comprise text identifying a caller, group information, or any other information related to transmission and reception of information over network 315. At step 803 context aware circuitry 309 determines a current context of device 300. As discussed above, the context-aware circuitry may comprise a level, a sensor that determines when the device is being held, positioning circuitry that determines a location and/or speed of the device, face-recognition circuitry that determines a position of a user's face in relation to the device, near-field distance circuitry, . . . , etc.

At step 805 processor 302 morphs at least a portion of the text to create anamorphic text based on the current context of the device. As discussed, the current context of the device may comprise on an angle of the display, if the device is being held, a location and/or speed of the device, or a position of the user's face in relation to the device, . . . , etc. The morphed text is output to display 304 and anamorphically displayed (step 807).

As discussed above, when the context-aware circuitry comprises a level, the logic circuitry morphs at least the portion of the text based on an angle of the display. When the context-aware circuitry comprises a sensor that determines when the device is being held, the logic circuitry morphs at least the portion of the text based on whether or not the device is being held. When the context-aware circuitry comprises positioning circuitry that determines a location of the device, the logic circuitry morphs at least the portion of the text based on the location of the device. When the context-aware circuitry comprises positioning circuitry that determines a speed of the device, the logic circuitry morphs at least the portion of the text based on the speed of the device. When the context-aware circuitry comprises face-recognition circuitry that determines a position of a user's face in relation to the device, the logic circuitry morphs at least the portion of the text based the position of the user's face in relation to the device.

It should be understood that morphing may take place based on more than one context. For example, context aware circuitry may comprise both a level, and sensor to determine if the device is being held. In this manner, morphing may take place when the device is not being held, and additionally based on an angle of the screen when not being held. When the device is held, no morphing takes place.

Additionally, as discussed above, certain display elements may be displayed anamorphically and other display elements may not be displayed anamorphically. For example, text may be displayed anamorphically, and symbols may not be displayed anamorphically, wherein the text comprises letters A through Z, and numbers 0 through 9 and wherein the symbols comprise elements other than text.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter

What is claimed is:

1. A device comprising:
communication circuitry receiving information to be displayed;
context-aware circuitry determining a current context of the device;
a processor morphing at least a portion of the text to create anamorphic text based on the current context of the device; and
a display, displaying the anamorphic text.

2. The device of claim 1 wherein the context-aware circuitry comprises a level and the logic circuitry morphs at least the portion of the text based on an angle of the display.

3. The device of claim 1 wherein the context-aware circuitry comprises a sensor that determines when the device is being held, and the logic circuitry morphs at least the portion of the text based on whether or not the device is being held.

4. The device of claim 1 wherein the context-aware circuitry comprises positioning circuitry that determines a location of the device, and the logic circuitry morphs at least the portion of the text based on the location of the device.

5. The device of claim 1 wherein the context-aware circuitry comprises positioning circuitry that determines a speed of the device, and the logic circuitry morphs at least the portion of the text based on the speed of the device.

6. The device of claim 1 wherein the context-aware circuitry comprises face-recognition circuitry that determines a position of a user's face in relation to the device, and the logic circuitry morphs at least the portion of the text based the position of the user's face in relation to the device.

7. The device of claim 1 wherein text is displayed anamorphically, and symbols are not displayed anamorphically.

8. The device of claim 7 wherein the text comprises letters A through Z, and numbers 0 through 9 and wherein the symbols comprise elements other than text.

9. A device comprising:
communication circuitry receiving information to be displayed;
a level determining an angle;
a sensor determining when the device is being held;
logic circuitry morphing at least a portion of the text to create anamorphic text based on the angle, and only when the device is not being held; and
a display, displaying the anamorphic text.

10. The device of claim 9 further comprising positioning circuitry that determines a location of the device, and the logic circuitry morphs at least the portion of the text based on the location of the device.

11. The device of claim 9 wherein text is displayed anamorphically, and symbols are not displayed anamorphically.

12. The device of claim 11 wherein the text comprises letters A through Z, and numbers 0 through 9 and wherein the symbols comprise elements other than text.

13. A method for operating a device, the method comprising the steps of:
receiving at communication circuitry, information to be displayed;
determining a current context of the device;
morphing at least a portion of the text to create anamorphic text based on the current context of the device; and
displaying the anamorphic text.

14. The device of claim 13 wherein the step of determining the current context comprises the step of determining an angle of the display.

15. The method of claim 13 wherein the step of determining the current context comprises the step of determining when the device is being held.

16. The method of claim 13 wherein the step of determining the current context comprises the step of determining a location of the device.

17. The method of claim 13 wherein the step of determining the current context comprises the step of determining a speed of the device.

18. The method of claim 13 wherein the step of determining the current context comprises the step of determining a position of a user's face in relation to the device.

19. The method of claim 13 wherein text is displayed anamorphically, and symbols are not displayed anamorphically.

20. The method of claim 19 wherein the text comprises letters A through Z, and numbers 0 through 9 and wherein the symbols comprise elements other than text.
